(19) United States
(12) Patent Application Publication
(10) Pub. No.: US 2020/0271538 A1
(43) Pub. Date: Aug. 27, 2020

(54) DEVICE AND METHOD FOR REPRODUCIBLE MEASUREMENT OF IMBALANCE ON ROTATING COMPONENTS WITH VARIABLE IMBALANCES

(71) Applicant: HOFMANN MESS-UND AUSWUCHTTECHNIK GMBH & CO. KG, Pfungstadt (DE)

(72) Inventors: Georg FISCHER, Gross-Umstadt (DE); Matthias PUFF, Bensheim (DE)

(21) Appl. No.: 16/794,381

(22) Filed: Feb. 19, 2020

(30) Foreign Application Priority Data
Feb. 27, 2019 (EP) 19000101.6

(51) Int. Cl. G01M 1/06; G01M 1/22

(52) U.S. Cl. CPC G01M 1/06; G01M 1/22

(57) ABSTRACT

A novel measurement method and a corresponding measurement setup for increasing the reproducibility and the accuracy of the measurement of the imbalance of rotating components with vagabond-like, variable imbalance behaviour. The rotating component has individual masses which are capable of vibrating and which can be moved independently of one another, which are employed, for example, in centrifugal force pendulums or torsional vibration absorbers of similar construction.

### FIELD OF THE INVENTION

The invention relates to a measurement setup and a measurement method for increasing the reproducibility and accuracy of the measurement of the imbalance of rotating components with vagabond-like, variable imbalance behaviour.

In particular, the invention relates to a measurement device and a method by means of which the measurement device is operated, in which the rotating component has variable imbalance, due to individual masses which are capable of vibrating and which can be moved independently of one another, which are employed, for example, in centrifugal force pendulums or torsional vibration absorbers of similar construction.

### BACKGROUND OF THE INVENTION

Imbalances exist in a rotating body if mass is distributed asymmetrically. The cause of imbalance can be, for example, wear, temperature-induced expansion, faulty installation or caused by production. This mass asymmetry can be compensated by attachment of correction weights.

Centrifugal force pendulums are in principle vibration absorbers for damping rotational or torsional vibrations. Owing to rotational speed proportionality, they are also known as adaptive vibration absorbers. Centrifugal force pendulums, as are widely used, for example, as a component of dual-mass flywheels (DMFs) in drive trains, in particular in automobile construction, in order cancel out the strong periodic rotational vibrations from the stroke movements of an internal combustion engine, in particular at low speeds, develop their action through the vibration of the pendulum mass generating a force against the direction of rotation of the engine.

Dual-mass flywheels (DMFs) are components of the drive train of modern motor vehicles (cars, buses, trucks) and serve to reduce rotational vibrations. They generally comprise a primary flywheel mass (engine side) and a secondary flywheel mass (gear-box side), which are connected to one another by spring damper units. The success of the DMF is based on substantially supercritical operation being possible compared with a torsion-damped clutch disc.

Centrifugal force pendulums, as employed here for the method according to the invention, generally have two or more individual masses (FIG. 1, see below), which are arranged symmetrically around the periphery of the rotating component and can move independently of one another, corresponding to the vibration forces acting on them. The said individual masses each have a degree of freedom in movement and an associated speed-specific natural frequency of the vibration absorber. The tuning of the absorber frequency is crucially dependent on the two radii r and R and the speed of rotation of the component. The theoretical principles are described, e.g., in Dresig, Holzweißig (Maschinendynamik [Machine Dynamics], Springer, 2011, ISBN 978-3-642-16009-7).

The position of the individual masses is thus initially random or even chaotic, which, owing to the position-dependent, initially different natural frequencies of the individual masses, leads to variable imbalances and contributes to the possibility of the state of imbalance of the rotating component, or of the centrifugal force pendulum, being different in the operating state than at the beginning. Depending on the movement state, different imbalance vectors of the individual masses thus arise. This causes the resultant vector to drift correspondingly, and both imbalance value and imbalance angle are subject to variation depending on the position of the individual masses at the time of measurement. A multiplicity of influences on the alignment of the individual masses before the measurement plays a role here. These can be, inter alia:

speed of rotation and thus centrifugal force

starting position of the individual masses

shape of the individual masses

mounting of the individual masses

constraint amongst the individual masses

different friction conditions

local surface roughness

temperature

It has hitherto been necessary to take relatively complex measures in order to obtain valid, reproducible and precise results when determining the imbalance of a component of this type. Thus, it is necessary to confirm the validity of each measurement result by means of a certain number of comparative measurements and assess the scatter of the results.

A number of possibilities for conditioning the rotating component have been described in the prior art, e.g.:

Spinning of the component at high speeds: The effect of centrifugal force causes the individual masses to move to the outside. If the guide radius r of the individual masses is sufficiently small, this method works very well. In the case of larger guide radii r, however, this method comes up against its limit, since the centrifugal forces act as perpendicular forces and lead to high frictional forces in the contact zone between the individual mass and the guide bolts.

Shaking of the component before the measurement process: Pure shaking can free the individual masses from any jammed position. However, considerable scatter in the measurement values must still be expected, since the individual masses cannot necessarily be brought into their central position.

Orientation of the individual masses through separate measures: The individual masses can be brought into their central position by conical elements which can be moved radially between two individual masses in each case.

All known methods for determination of the imbalance of centrifugal force pendulums or similar torsional vibration absorbers have proven to be relatively complex and/or not fully reproducible.

The object was therefore to develop a novel measurement method for the determination of imbalances on rotating components with variable or vagabond-like imbalances, in particular centrifugal force pendulums or similar devices, which gives highly reproducible and precise results of the states of imbalance in components of this type, and in addition can be carried out simply and quickly.

The object has been achieved by the provision of a novel measurement method and a novel measurement device with which the method is carried out, as described in greater detail below and in the claims.

### SUMMARY OF THE INVENTION

The invention thus relates to a measurement device and a method for increasing the reproducibility and accuracy of imbalance measurements by simulation of possible later operating states on a rotationally symmetrical component to be balanced which rotates about an axis of rotation and has, mostly on the periphery, a plurality of individual masses which are capable of vibration and can be moved independently of one another, essentially comprising the said rotating component and a drive device having a measurement spindle, preferably integrated into the drive, which holds the said rotating component and sets it in rotation and is fitted with a sensor and measurement unit for determining the vibrations generated by imbalances occurring on the rotating component, where the drive device with measurement spindle has, in accordance with the invention, a direct drive, preferably a torque drive or another comparable direct drive with high dynamics and a large acceleration capacity and torque, and in addition comprises a mechanism or device, including control units, which is capable of stimulating the rotating component temporarily with a periodic or harmonic vibration having an amplitude which is variable over time, preferably initially constant and then decreasing, whose frequency essentially corresponds to the natural frequency of the individual masses, before or during the measurement at a selected speed of rotation of the rotating component, where the temporary stimulation is superimposed on the vibrations of the rotating component that are caused by the imbalance and has the effect that the originally randomly arranged individual masses of the rotating component align symmetrically with one another in relation to the axis of rotation of the rotating component.

In particular, the invention relates to a method for the reproducible determination of the state of imbalance of a rotating, rotationally symmetrical component, as described above, which essentially comprises four steps, where the second step in particular is essential to the invention.

These steps are in detail:

(i) acceleration of the rotating component to be a balanced to a selected measurement speed of rotation which is matched to the rotating component in question, by means of a dynamic direct drive which is capable of high torques (acceleration phase). The acceleration ramp must be determined component-specifically and adjusted to an optimum value to avoid an arrangement of the individual masses in a non-desirable final position.
(ii) superimposition of a periodic or harmonic stimulation vibration having an amplitude which is variable over time and a frequency which essentially corresponds to the natural frequency of the individual masses of the rotating component onto the vibrations caused by the rotating component at the selected measurement speed of rotation, where the stimulation vibration is either generated by the direct drive or is generated by a second drive or by an external imbalance generator and is continued until the originally randomly arranged individual masses of the rotating component have become settled in a common symmetrical central position in relation to the axis of rotation (stimulation phase),
(iii) performance of the actual measurement of the state of imbalance after the periodic or harmonic stimulation vibration has subsided (measurement phase), and
(iv) braking of the rotating component after determination of the parameters of the state of imbalance thereof (delay phase). The deceleration ramp mut be determined component-specifically and adjusted to an optimum value to avoid an arrangement of the individual masses in a non-desirable final position, provided that this is necessary for further processing.

In a preferred embodiment of the invention, the stimulation vibration is provided with an initially constant and then decreasing amplitude.

In a further preferred embodiment of the invention, the direct drive has an integrated measurement spindle.

The measurement method presented here, and the measurement device on which this method is based, have a number of advantages with unique features: The combination of the special measurement setup with a measurement spindle and the integrated torque motor principle described without additional gearing and the specifically manipulated characteristics of motor control for achievement of a temporary overtone by means of the same or a separate drive was hitherto not known as an available technical solution.

Current systems frequently have an additional gearbox or a belt drive, but these do not meet the requirements of the requisite dynamics and the requisite lifetime. Systems without supplementary transmission in turn do not have sufficient torque reserve in order to achieve the dynamics required.

The advantageous unique features are in detail:

Maximum dynamics through torque motor characteristics

The solution described orients the chaotically located centrifugal force pendulums into a symmetrical order directly on the imbalance measurement spindle and thus simulates the “true state of imbalance” that comes closest to the later operating mode.

The solution described allows a significant improvement in the reproducibility of the imbalance measurement of centrifugal force pendulums compared with conventional methods.

There is the possibility of simple parallel parametrisation of the setup via the motor control software, so that various operating modes can easily be achieved for different component types. For example, centrifugal force pendulums can thus be conditioned for 3, 4 or 6 cylinder internal combustion engines using a single setup.

The setup and method can consequently be used for different component sizes and vibration absorber natural frequencies. There is no need for mechanical adaptations to the setup.

The setup described and the method for conditioning centrifugal force pendulums can in principle also be employed in other areas of technology besides the illustrative use described in the drive train of an internal combustion engine.

In particular, applications are contemplated in which rotational vibrations have to be damped by means of centrifugal force pendulums, and balancing of the centrifugal force pendulums in the course of the manufacturing process is necessary. Mention may be made here by way of example of applications in drive trains of engines and machines, for example wind turbines, reciprocating compressors, power station turbines and generators.

### BRIEF DESCRIPTION OF THE DRAWINGS

FIG. 1A represents an example of a centrifugal force pendulum which can be employed in accordance with the invention;

FIG. 1B is an end view thereof;

FIG. 2 shows the measurement setup, according to the invention, with a torque motor as direct drive, a centrifugal force pendulum situated on a measurement spindle, and a motor control device, which temporarily generates harmonic vibrations that are capable of stimulating the individual masses of the centrifugal force pendulum with their natural frequencies.

FIG. 3A is a graph of showing an acceleration phase, a measurement phase for imbalance determination and a delay phase; FIG. 3B is a graph of showing the amplitude, frequency, duration and attenuation constant during the stimulation phase; and FIG. 3C is an enlargement of the stimulation phase of FIG. 3B;

FIGS. 4A and 4B show an example of stimulation of a centrifugal force pendulum with tuning for the 2^{nd} engine order of an internal combustion engine;

FIG. 5A depicts how the separations of the individual masses with respect to the sensor are determined and, in FIG. 5B depicts how the separate separation in the radial direction is determined for each individual mass.

FIG. 6 is a graph depicting an extension of the use of the method according to the invention.

### DETAILED DESCRIPTION OF THE INVENTION

Description of the Measurement Device According to the Invention

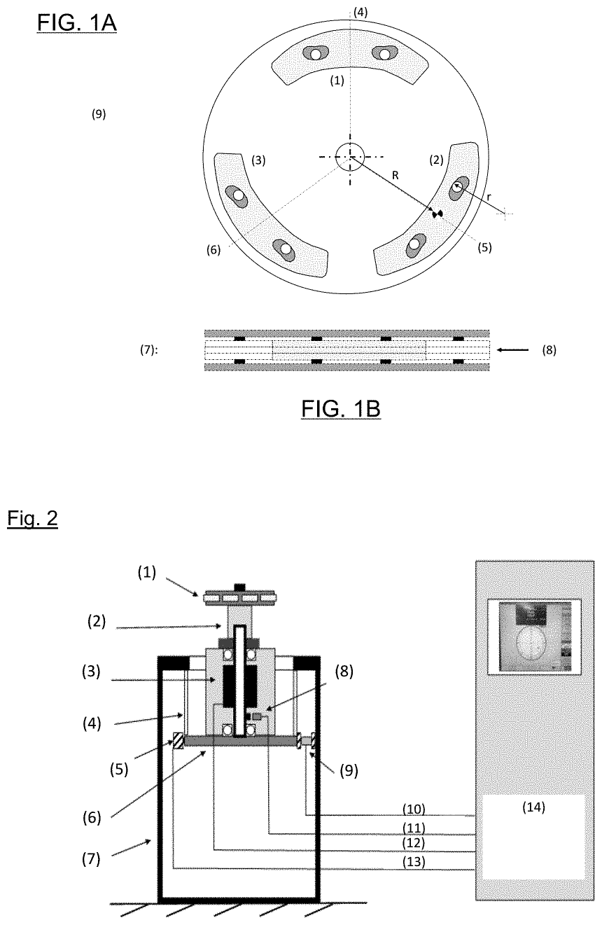

The measurement setup described in this invention and the measurement method represent a novel way of being able to carry out a reproducible measurement of the imbalance of the centrifugal force pendulums described above (FIG. 1). The position and movement of the individual masses are brought specifically to a defined state by the method. They each adopt a symmetrical position corresponding to their geometrical central position. The summation of the individual imbalance vectors thus enables a stable measurement of the true imbalance value and imbalance angle with prior definition of an allowed scattering circle radius.

FIG. 1 represents, as stated, an example of a centrifugal force pendulum, as can be employed in accordance with the invention. The reference numerals here have the following meanings:

(1) Absorber mass 1; (2) Absorber mass 2; (3) Absorber mass 3; (4) Midline 1; (5) Midline 2; (6) Midline 3; (7) Side view of the centrifugal force pendulum; (8) Multilayered absorber masses; (9) Plan view of the centrifugal force pendulum.

The measurement setup is based on a measurement spindle with direct drive that is designed particularly with respect to dynamics and precision. Direct drive means that the component to be measured is clamped directly on the drive shaft of the drive and no intermediate gearing or belt transmission is used. The drive itself has a compact structure with optimised mass moment of inertia. At the same time, a high acceleration capacity of the drive is required in order to be able to use the method described in this invention. A further requirement of the structure of the direct drive is the integrated design with a high-precision measurement spindle. For measurement technology of a balancing machine in particular, extremely high accuracies are required here in relation to round running, flat running and reproducibility under various axial and radial loads.

As an example of direct drive, mention may be made, in particular, of the torque motor, which, owing to the large winding diameter, achieves extremely high torques (>1500 Nm) and thus extremely high dynamics. The absence or omission of a gearbox or a belt transmission is a further crucial factor for direct and slip-free transmission of torques and is also a prerequisite for the measurement method presented below. The large winding diameter brings the further advantage that the measurement spindle mounting can be integrated into the drive.

A further advantage of the torque motor is that it can be regulated very well owing to low interfering parameters and high repetition accuracy and is virtually wear-free.

FIG. 2 shows the measurement setup according to the invention with a torque motor as direct drive, a centrifugal force pendulum situated on a measurement spindle, and a motor control device, which temporarily generates harmonic vibrations that are capable of stimulating the individual masses of the centrifugal force pendulum with their natural frequencies. The reference numerals here have the following meanings:

(1) Centrifugal force pendulum; (2) Radially acting chuck including a slaving pivot engaging the component for intake of a torque; (3) Direct drive (4) Springs; (5) Vibration sensor (distance-measuring system); (6) Vibrator base plate; (7) Frame; (8) Speed sensor (e.g. incremental or impulse sensor; (9) Piezoelectric sensor (force-measuring system); (10) Imbalance signal (force measuring); (11) Speed: (12) Motor current; (13) Imbalance signal (distance measuring); (14) Hardware and software for motor control, imbalance measurements and visualisation.

In detail, the measurement setup essentially consists of a frame, which is firmly anchored to the ground. The measurement spindle with direct drive (e.g. a torque spindle) and chuck are fixed to a base plate and suspended by means of spring elements. The component is held by the chuck. The tuning of the springs depends on the design principle of the imbalance measurement method, a distinction being made between soft and hard tuning.

In the case of soft tuning, a vibration sensor is used on the vibrator base plate. In the case of hard, force-measuring tuning, a piezoelectric sensor is employed between frame and base plate. The setup can furthermore be designed for 1- or 2-plane measurement methods.

The 1-plane method is employed as standard for flat, cylindrical components, i.e. if the component diameter generally comes out greater than the component length. In this case, determination of the imbalance with an imbalance vector is sufficient. Only a vibration sensor or piezoelectric sensor is therefore required.

The 2-plane method is employed in the case of components if the component length generally comes out greater than the component diameter. In this case, the imbalance is described by means of 2 imbalance vectors with a certain plane separation. In this case, 2 vibration or piezoelectric sensors are employed in a corresponding bearing separation.

Description of the Measurement Method of the Process According to the Invention

The aim of the component conditioning according to the invention consists in ordering the individual masses of the rotating component to their central position. The gradual reduction of the superimposed stimulation amplitude here results in a reduction in the vibration amplitude of the individual masses. This effect is ultimately utilised in order to achieve increased reproducibility of the imbalance measurement. Whereas the conventional imbalance measurement method is composed of an acceleration phase, a measurement phase and a braking phase, the novel method is supplemented by a further stimulation phase. To this end, the standard engine control software is deliberately disrupted and a harmonic vibration with decreasing amplitude is superimposed on the actual measurement speed.

The idea of the superimposed harmonic vibration has the aim of stimulating the individual masses with the frequency that corresponds precisely to their natural frequency. This stimulation can also be compared with simulation of the stimulation caused by the internal combustion engine, which is intentionally imposed on the centrifugal force pendulum in order to set the individual masses in motion. This stimulation is imposed on the measurement speed of rotation over a certain period and subsequently moved towards zero. When the stimulation phase is completed, the constant measurement speed of rotation is maintained. The individual masses are then in their respective central position and the imbalance measurement process can be carried out.

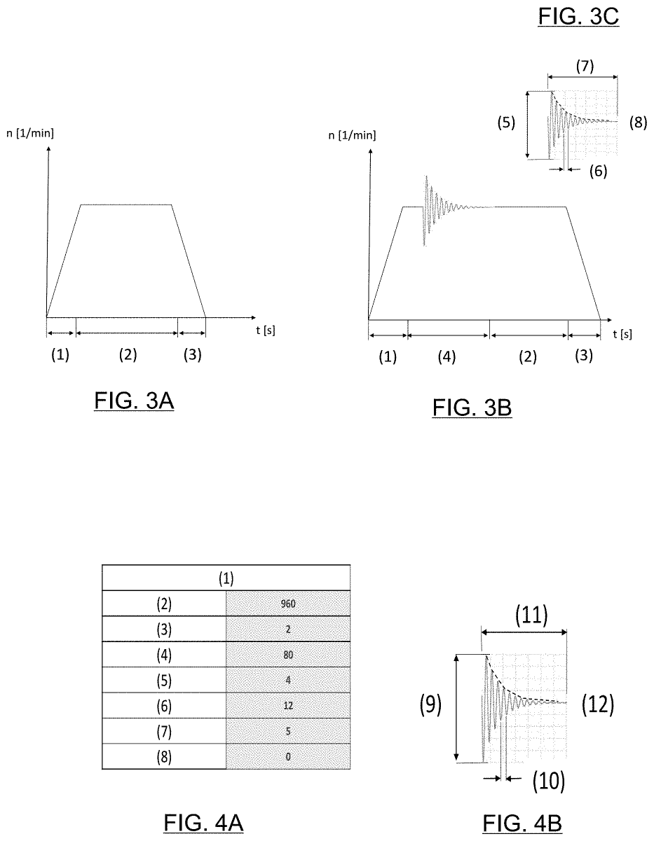

The speed of rotation/time curve for a centrifugal force pendulum is depicted in FIG. 3 for the conventional imbalance measurement method (3a) and for the newly developed measurement method (3b) by means of a harmonic vibration with decreasing amplitude superimposed on the speed of rotation (stimulation phase) and subsequent measurement phase. The reference numerals in FIG. 3 have the following meanings:

(1) Acceleration phase; (2) Measurement phase for imbalance determination (3) Delay phase; (4) Stimulation phase; (5) Amplitude; (6) Frequency; (7) Duration; (8) Attenuation constant

The stimulation in the present case can, owing to the enormous dynamics advantage, be transmitted directly to the component via the direct drive described above (e.g. a torque motor). It is also conceivable to equip the measurement setup described above with a separate imbalance source. This can be, for example, an additional motor with disc rotor and an imbalance mass installed off-centre. This imbalance generator can then be accelerated to the desired speed of rotation during the stimulation phase in parallel to the rotating component and stimulate the individual masses.

An example of stimulation of a centrifugal force pendulum with tuning for the 2^{nd} engine order of an internal combustion engine will be described below (FIG. 4):

The reference numerals used here have the following meanings:

(1) Example parameter for centrifugal force pendulum detuning for an internal combustion engine with tuning to the 2^{nd} engine order; (2) Engine speed (idling); (3) Periods per rotation; (4) Maximum amplitude of the stimulation; (5) Minimum amplitude of the stimulation; (6) Duration of the stimulation; (7) Amplitude reduction; (8) Loop counter (repetitions of the stimulation); (9) Amplitude; (10) Frequency; (11) Duration; (12) Attenuation constant.

The measurement spindle is firstly accelerated to the engine idling speed, in the present case 960 1/min. The additional superimposition frequency with two periods per engine rotation is subsequently superimposed on the base speed. This is referred to as modulation of the engine speed with a 2d order overtone, i.e. twice the base frequency. The individual masses of the pendulum vibration absorber are matched to this speed range and then begin to vibrate due to the specific stimulation in the resonance range. The vibration amplitude of the stimulation is defined via the attenuation (4) as to be 80 1/min in FIG. 4. The duration of the action is defined as to be 12 s over a period (6). The curve here can follow an attenuation curve or be terminated abruptly at the end of the period. The attenuation behaviour of the vibration is described via the attenuation constant, parameter (7), in FIG. 4. Finally, it is possible to maintain a minimum amplitude, parameter (5), in FIG. 4 after completion of the action phase. The action of the stimulation of vibration can be carried out consecutively several times, and can be determined by the loop counter (8) in FIG. 4. On the right side of FIG. 4, the stimulation amplitude (9), the frequency of the superimposed vibration (10), the period of stimulation (11) and the attenuation curve (12) is depicted.

Examination of the Efficacy of the Method According to the Invention

After the stimulation phase, which serves to specifically align the individual vibration absorber masses in their symmetrical position to one another in relation to the axis of rotation, a number of methods can be used to examine the efficacy of the method.

In general, these can be the following:
image processing (e.g. high speed camera)
vibration or sound measurement (e.g. microphone, solid-borne sound sensor) separation measurement (e.g. laser-based)

The idea consists in checking the position of the individual masses relative to one another.

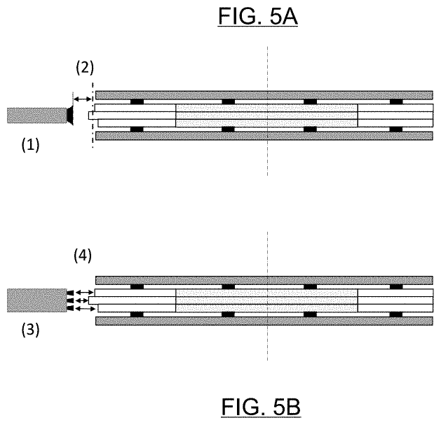

FIG. 5(a)(b) illustrates the principle with reference to a measurement of the separation of the vibration absorber masses of the centrifugal force pendulum, where the reference numerals have the following meanings:
(1) sensor for position recognition of the vibration absorber masses with averaging;
(2) recorded averaged position of the vibration absorber masses (length of the dimension arrow in FIG. 5(a));
(3) sensor for position recognition of the individual vibration absorber mass;
(4) recorded, discrete positions of each individual vibration absorber mass (length of the dimension arrow in FIG. 5(b)).

FIG. 5(a) depicts how the separations of the individual masses with respect to the sensor are determined as an averaged value in the radial direction. In FIG. 5(b), a separate separation in the radial direction is determined for each individual mass. For this purpose, use is made of a sensor with multiple recording or several sensors arranged in parallel. The evaluation must be carried out at least for one complete revolution. It is also possible to use a number of revolutions and take averages of the measured values.

With the aid of the method, it is possible to evaluate both separation differences between the individual vibration absorber masses in the radial direction and also in the peripheral direction. The criterion to be evaluated for successful symmetrical alignment of the individual masses is the achievement of symmetrical separation profiles for all individual vibration absorber masses of the rotor over a complete rotation of the rotor through 360°. Corresponding tolerance regions between the recorded separations must be stipulated in order to be able to use the method in practice. If the stipulated tolerance range is exceeded, a fresh stimulation phase or a corresponding classification of the rotor must be carried out.

The advantage of this efficacy examination consists in being able to carry out a validation of the alignment of the individual masses in relation to the axis of rotation after the stimulation phase has taken place.

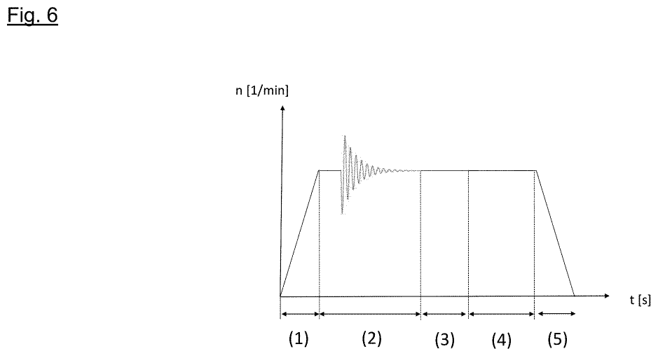

In accordance with the procedure described, an extension of the method procedure as depicted in FIG. 6 arises on use of the method according to the invention. The reference numerals here have the following meanings:

(1) Acceleration phase; (2) Stimulation phase; (3) (Efficacy) examination of the alignment of the vibration absorber masses; (4) Choice: Measurement phase for determination of the imbalance or retry of the stimulation phase of (2); (5) Delay phase.

1-17. (canceled)

18. A measurement device for increasing reproducibility and accuracy of imbalance measurements by simulation of possible later operating states on a rotationally symmetrical component to be balanced which rotates about an axis of rotation and has a plurality of individual masses which are capable of vibration and can be moved independently of one another, substantially comprising:
the rotating component and a drive device having a measurement spindle which holds the rotating component and sets it in rotation and is fitted with a sensor and measurement unit for determining the vibrations generated by imbalances occurring on the rotating component,
wherein the drive device with measurement spindle has a direct drive with high dynamics and a large acceleration capacity and torque and comprises a mechanism or device, including control units, which is capable of stimulating the rotating component temporarily with a periodic or harmonic vibration having an amplitude which is variable over time whose frequency essentially corresponds to a natural frequency of the individual masses, before or during the measurement at a selected speed of rotation of the rotating component, where the temporary stimulation is superimposed on the vibrations of the rotating components that are caused by the imbalance and has the effect that the originally randomly arranged individual masses of the rotating component align symmetrically with one another in relation to the axis of rotation of the rotating component.

19. The measurement device according to claim 18, wherein the drive device is a torque motor.

20. The measurement device according to claim 18, wherein the measurement spindle is an integral constituent of the drive device.

21. The measurement device according to claim 18, wherein the rotationally symmetrical component to be balanced is a torsional vibration absorber.

22. The measurement device according to claim 21, wherein the torsional vibration absorber is a centrifugal force pendulum.

23. The measurement device according to claim 22, wherein the centrifugal force pendulum has at least two individual masses distributed uniformly on a periphery thereof.

24. The measurement device according to claim 18, wherein the stimulation of the periodic or harmonic vibration takes place directly by the drive device or takes place via an external imbalance generator.

25. Use of the measurement device according to claim 18 for the precise and reproducible determination of imbalances in centrifugal force pendulums of dual-mass flywheels or clutches as a constituent of drive trains of internal combustion engines or other engines or machines.

26. A method for reproducible determination of the state of imbalance of a rotating, rotationally symmetrical component which comprises a plurality of individual masses which are capable of vibration and are movable and mounted independently of one another, where the state of movement of the rotating component corresponds to a selected later operating mode or comes closest to it, wherein the method substantially comprises:
(i) accelerating the rotating component to be a balanced by a dynamic direct drive which is capable of high torques to a selected measurement speed of rotation which is matched to the rotating component in question (acceleration phase);
(ii) superimpositing a periodic or harmonic stimulation vibration, having an amplitude which is variable over time and a frequency which substantially corresponds to a natural frequency of the individual masses of the rotating component, onto the vibrations caused by the rotating component at the selected measurement speed of rotation, where the stimulation vibration is carried out until the originally randomly arranged individual masses of the rotating component have become settled in a common symmetrical central position in relation to an axis of rotation (stimulation phase);
(iii) performing the actual measurement of a state of imbalance after the periodic or harmonic stimulation vibration has subsided (measurement phase); and
(iv) braking of the rotating component after determination of the parameters of the state of imbalance thereof (delay phase).

27. The method according to claim 26, wherein the periodic or harmonic stimulation vibration is carried out with an initially constant amplitude, followed by an amplitude which decreases over time.

28. The method according to claim 26, wherein the generation of the periodic or harmonic stimulation vibration is carried out with aid of the direct drive itself.

29. The method according to claim 26, wherein the generation of the periodic or harmonic stimulation vibration is carried out with aid of a separate imbalance-generating drive device or by an external imbalance generator.

30. The method according to claim 26, wherein a torque motor is employed as direct drive.

31. The method according to claim 26, wherein the rotating component employed is a centrifugal force pendulum having at least two individual masses.

32. The method according to claim 26, wherein the direct drive has an integrated measurement spindle.

33. The method according to claim 26, wherein an examination of the efficacy of the imbalance measurement is carried out.

34. The method according to claim 26, wherein the method uses a measurement device measurement device for increasing reproducibility and accuracy of imbalance measurements by simulation of possible later operating states on a rotationally symmetrical component to be balanced which rotates about an axis of rotation and has a plurality of individual masses which are capable of vibration and can be moved independently of one another, substantially comprising:
the rotating component and a drive device having a measurement spindle which holds the rotating component and sets it in rotation and is fitted with a sensor and measurement unit for determining the vibrations generated by imbalances occurring on the rotating component,
wherein the drive device with measurement spindle has a direct drive with high dynamics and a large acceleration capacity and torque and comprises a mechanism or device, including control units, which is capable of stimulating the rotating component temporarily with a periodic or harmonic vibration having an amplitude which is variable over time whose frequency essentially corresponds to a natural frequency of the individual masses, before or during the measurement at a selected speed of rotation of the rotating component, where the temporary stimulation is superimposed on the vibrations of the rotating components that are caused by the imbalance and has the effect that the originally randomly arranged individual masses of the rotating component align symmetrically with one another in relation to the axis of rotation of the rotating component.
